(19) United States
(12) Patent Application Publication
(10) Pub. No.: US 2008/0036859 A1
(43) Pub. Date: Feb. 14, 2008

(54) Digital surveillance camera

(76) Inventors: Yuh-Chin Chang, Hsinchu Hsien (TW); Hui-Ya Chou, Hsinchu City (TW)

Correspondence Address: Thomas E. Sisson;Jackson Walker, LLP, Suite 2100, 112 E. Pecan, San Antonio, TX, 78205, US

(21) Appl. No.: 11/502,895

(22) Filed: Aug. 11, 2006

(51) Int. Cl. H04N 7/18

(52) U.S. Cl. 348/143

(57) ABSTRACT

A digital surveillance camera includes a video capture component, a data converter coupled to the video capture component and a signal transmission unit coupled to an output terminal of the data converter. The data converter processes the video signal with high frequency components from the video capture component in digital domain to generate the video signal in a specific format to be further transmitted in the digital serial differential form. The signal transmission unit transmits the signal via either an optical fiber or a cable with characteristics of long-distance transmission and lowers the resulting signal loss to ensure the quality of the received video signal.

### BACKGROUND OF THE INVENTION

1. Field of the Invention

The invention relates to a digital surveillance camera, and more particularly to a digital surveillance camera that can convert a captured video signal to an optical signal or an electric signal for long-distance transmission with an optical fiber or a cable, so as to improve the resolution of the captured video.

2. Description of the Related Art

Lately plasma televisions or LCD (liquid crystal display) televisions of high resolution and big screen are mass manufactured and become popular. With this tendency, a CCTV (closed circuit television) system is developed to be digitalized. In other words, the development of a surveillance system capable of receiving, processing and transmitting the digital video signals is definitely positive. However, the output signals of the present surveillance camera are still in the analog format, which can only offer comparatively the lower resolutions of the captured video in an interlaced scanned fashion with a limited transmission distance because of the rapid signal decay during transmission.

### SUMMARY OF THE INVENTION

The present invention provides a digital surveillance camera that uses a CCD or CMOS sensor with high resolution as the video capturing component and also processes the generated video signal with high frequency (1.485 Gbps) components purely in the digital domain, wherein the underlying transmission media for the digital signals are selected from the materials of high bandwidth, low cost and long-distance transmission.

To achieve the above objectives, the digital surveillance camera includes a video capture component, a data converter coupled to the video capture component and a signal transmission unit coupled to an output terminal of the data converter. The data converter performs a high-frequency process on the uncompressed video signal output from the video capture component to make the video signal meet a specific format to be further serially transmitted in a differential form. The signal transmission unit transmits the signal via either an optical fiber or a cable with characteristics of long-distance transmission and lower signal loss to ensure the quality of the received video signal.

### BRIEF DESCRIPTION OF THE DRAWINGS

FIG. 1 is a functional block diagram of a digital surveillance camera in accordance with the present invention;

FIG. 2 is a functional block diagram of a data converter in accordance with the present invention; and

FIG. 3 is a functional block diagram of a video processor of the data converter of the present invention.

### DETAILED DESCRIPTION OF THE INVENTION

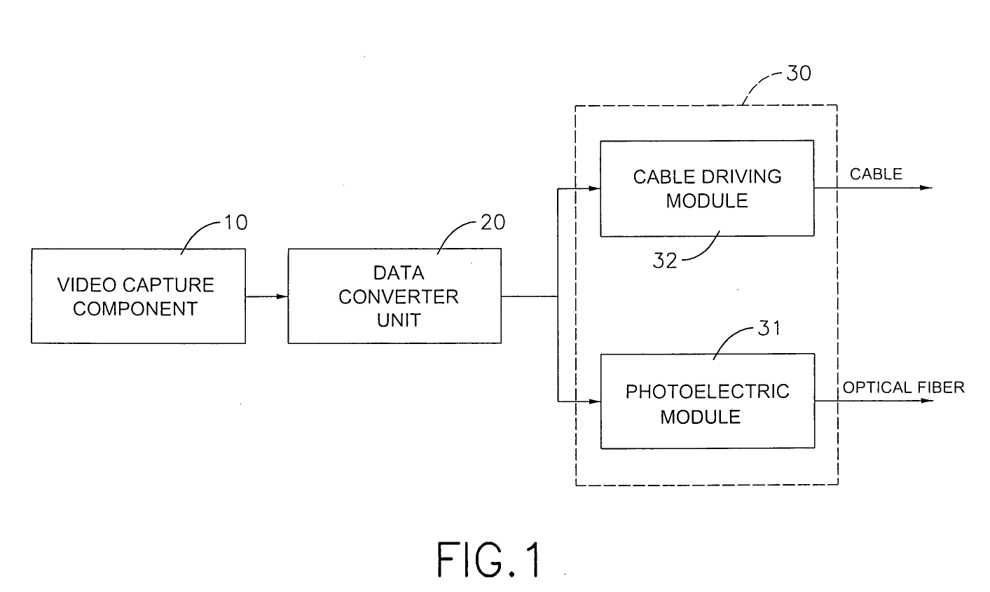

With reference to FIG. 1, a digital surveillance camera of the present invention includes a video capture component 10, a data converter 20 and a signal transmission unit 30.

The video capture component 10 can be a CCD or CMOS sensor with high resolution to capture a video signal. An output video signal of the video capture component 10 can be in the formats of RGB, YUV or YCbCr.

The data converter 20, using a high-frequency process performed in digital domain, converts the video signal output from the video capture component 10 to a specific format and then serially transmits the processed video signal in a differential form. Therefore, the data converter 20 outputs a digital serial differential signal. The data converter 20 will be discussed in detail hereinafter.

The signal transmission unit 30 is connected to an output terminal of the data converter 20 to transmit the video signal via one or multiple kinds of transmission media. In this preferred embodiment, the signal transmission unit 30 comprises a photoelectric module 31 and a cable driving module 32. The photoelectric module 31 and the cable driving module 32 are coupled to an output terminal of the data converter 20. The photoelectric module 31 converts the received digital serial differential signal into an optical signal, transmitted via an optical fiber. The cable driving module 32 is used to ensure that the received serial differential signal meets with the SMPTE (Society of Motion Picture and the Television Engineers) standard. Therefore, the processed serial differential signal can be transmitted via a cable of 75 ohms with the desired distance. With this embodiment, the digital surveillance camera in accordance with the present invention can transmit the video signal either by the optical fiber or by the cable.

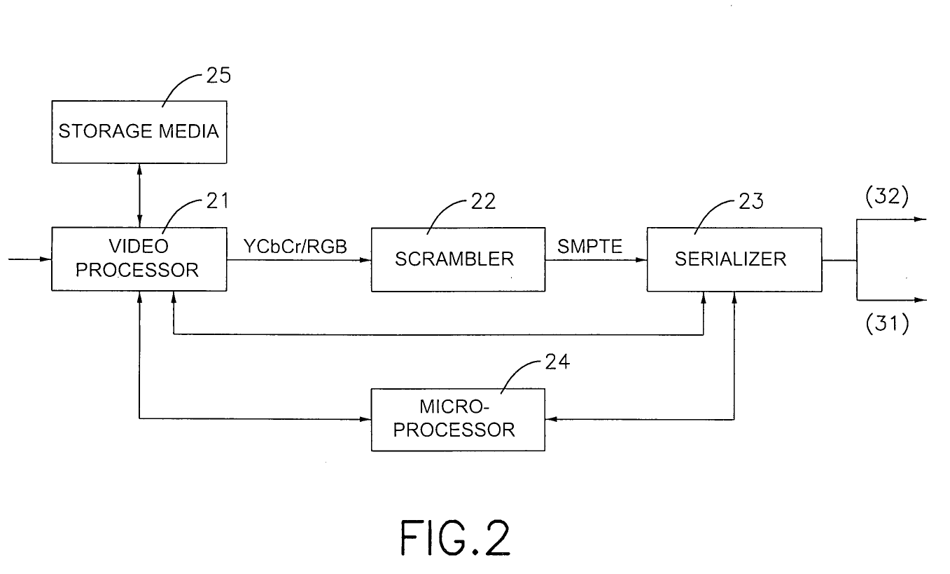

With reference to FIG. 2, a detailed description of the data converter 20 is illustrated as follows. The data converter 20 comprises a video processor 21, a scrambler 22, a serializer 23, a microprocessor 24 and a storage media 25.

The video processor 21 is used to ensure that an input progressed video meets with the SMPTE standard or the RGB format. The video processor 21 is coupled to the storage media 25 through a bus, so that data of the video processor 21 can be stored in the storage media 25. In this preferred embodiment, the storage media 25 is a DDR/DDR2 memory.

The scrambler 22 scrambles a signal output from the video processor 21 to reduce possible errors during the data transmission and to encrypt the data.

The serializer 23 is coupled to an output terminal of the scrambler 22 to convert a parallel signal output from the scrambler 22 into a serial signal. The serializer 23 then outputs the serialized signal.

The microprocessor 24 is coupled to the video processor 21, the scrambler 22 and the serializer 23 to control the operations of the video processor 21, the scrambler 22 and the serializer 23. The microprocessor 24 can further determine whether or not to enable the scrambler 22 when the optical fiber is selected to transmit the video signal.

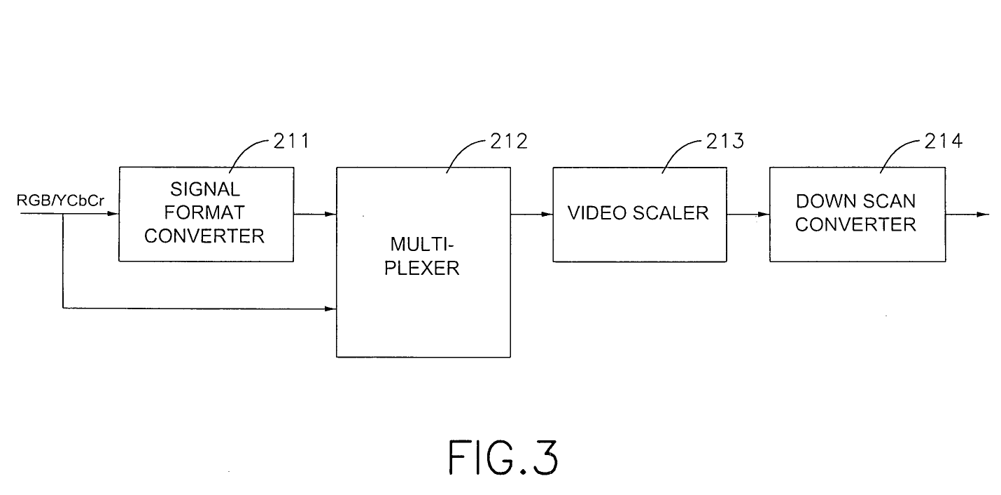

With reference to FIG. 3, a detailed description of the video processor 21 is illustrated as follows. The video processor 21 includes a signal format converter 211, a multiplexer 212 and a video scaler 213.

The signal format converter 211 has an input terminal coupled to the output terminal of the video capture component 10 and converts the received RGB formatted video into the YCbCr/YUV representation. The multiplexer 212 has one input directly from the signal format converter 211 and the other input from the video capture component 10. Depending upon the requirement on the output format, either RGB or YCbCr, of the format converter 211, the signal format converter 211 behaves differently. When the video capture component 10 generates the RGB (YCbCr) formatted video signal and the signal format converter 211 work in the YCbCr (RGB) domain, the converter 211 transforms the RGB (YCbCr) formatted video signal into the YCbCr (RGB) signal and then outputs the YCbCr (RGB) signal to the multiplexer 212. When the output signal of the video capture component 10 is already in YCbCr (RGB) representation, the YCbCr (RGB) video signal is sent directly from the video capture component 10 to the multiplexer 212. Therefore, whether the YCbCr or RGB video signal to be further processed after the multiplexer stage is guaranteed in YCbCr (RGB) domain.

The video scaler 213 is connected to an output terminal of the multiplexer 212 to adjust the resolution of the video output from the multiplexer 212 and then outputs the resized video to a down scan converter 214.

The down scan converter 214 converts the resized progressed video signal output from the video scaler 213 into an interlaced signal, while an interlaced video output is preferred. Therefore, in this invention, a down scan converter 214 can be omitted, if no interlaced signals are under concerns.

To sum up, the present invention provides a digital surveillance camera that can convert a captured video signal to either an optical signal or an electric signal for a long-distance transmission via the optical fiber or the cable. With these signal transmission media, the present invention is capable of transmitting the very high resolution video with comparatively low cost. In addition, the digital surveillance camera uses a CCD or CMOS sensor as the video capture component so that the high quality of the captured videos can be ensured.

Even though numerous characteristics and advantages of the present invention have been set forth in the foregoing description, together with details of the structure and function of the invention, the disclosure is illustrative only. Changes may be made in detail, especially in matters of shape, size, and arrangement of parts within the principles of the invention to the full extent indicated by the broad general meaning of the terms in which the appended claims are expressed.

What is claimed is:

1. A digital surveillance camera comprising:
a high resolution video capture component for capturing a video signal and outputting the video signal in a format of RGB, YUV or YCbCr;
a data converter connected to the high resolution video capture component to perform a high-frequency process on the video signal output from the video capture component to make the video signal meet a specific format to be further output in a digital serial differential signal form; and
a signal transmission unit connected to an output terminal of the data converter to convert the digital serial differential signal and then to output a converted digital serial differential signal via a transmission media.

2. The digital surveillance camera as claimed in claim 1, the signal transmission unit comprising:
a photoelectric module to convert the digital serial differential signal to an optical signal; and
an optical fiber used as the transmission media to transmit the optical signal from the electric to optical converter module.

3. The digital surveillance camera as claimed in claim 1, the signal transmission unit comprising:
a cable driving module coupled to the output terminal of the data transmission unit; and
a cable used as the transmission media.

4. The digital surveillance camera as claimed in claim 2, the signal transmission unit comprising:
a cable driving module coupled to the output terminal of the data transmission unit; and
a cable used as the transmission media.

5. The digital surveillance camera as claimed in claim 3, the data converter comprising:
a video processor for converting an input progressed video to a specific format;
a scrambler connected to the video processor to scramble the video signal output from the video processor;
a serializer coupled to an output terminal of the scrambler to convert a parallel signal output from the scrambler to a serial signal;
a microprocessor coupled to the video processor, the scrambler and the serializer to control the video processor, the scrambler and the serializer; and
a storage media coupled to the video processor for storing data.

6. The digital surveillance camera as claimed in claim 4, the data converter comprising:
a video processor for converting an input progressed video to a specific format;
a scrambler connected to the video processor to scramble a video signal output from the video processor;
a serializer coupled to an output terminal of the scrambler to convert a parallel signal output from the scrambler to a serial signal;
a microprocessor coupled to the video processor, the scrambler and the serializer to control the video processor, the scrambler and the serializer; and
a storage media coupled to the video processor for storing data.

7. The digital surveillance camera as claimed in claim 5, the video processor comprising:
a signal format converter having an input terminal coupled to an output terminal of the video capture component to convert the video signal output from the video capture component into an YCbCr or RGB format;
a multiplexer having an input from the signal format converter and another input coupled to an output of the video capture component; and
a video scaler coupled to an output terminal of the multiplexer to adjust a resolution of the video picture output from the multiplexer.

8. The digital surveillance camera as claimed in claim 7, wherein the video processor further comprises a down scan converter coupled to the video scaler to convert the adjusted video signal into an interlaced signal.

9. The digital surveillance camera as claimed in claim 6, the video processor comprising:
a signal format converter having an input terminal coupled to an output terminal of the video capture component to convert the video signal output from the video capture component into an YCbCr or RGB format;
a multiplexer having an input from the signal format converter and another input coupled to an output of the video capture component;
a video scaler coupled to an output terminal of the multiplexer to adjust a resolution of the video picture output from the multiplexer.

10. The digital surveillance camera as claimed in claim 9, wherein the video processor further comprises a down scan converter coupled to the video scaler to convert the adjusted video signal into an interlaced signal.

11. The digital surveillance camera as claimed in claim 7, wherein the storage media is a DDR/DDR2 memory.

12. The digital surveillance camera as claimed in claim 8, wherein the storage media is a DDR/DDR2 memory.

13. The digital surveillance camera as claimed in claim 9, wherein the storage media is a DDR/DDR2 memory.

14. The digital surveillance camera as claimed in claim 10, wherein the storage media is a DDR/DDR2 memory.

15. The digital surveillance camera as claimed in claim 1, wherein the video capture component is a CCD or CMOS sensor.
